(19) United States
(12) Patent Application Publication
(10) Pub. No.: US 2017/0153930 A1
(43) Pub. Date: Jun. 1, 2017

(54) APPLICATION CONTAINER RUNTIME

(71) Applicant: COREOS, INC., San Francisco, CA (US)

(72) Inventors: Brandon Philips, San Francisco, CA (US); Alex Polvi, San Francisco, CA (US); Jonathan Boulle, San Francisco, CA (US)

(21) Appl. No.: 14/954,926

(22) Filed: Nov. 30, 2015

(51) Int. Cl. G06F 9/54; G06F 3/0484

(52) U.S. Cl. CPC G06F 9/543; G06F 3/0484

(57) ABSTRACT

Disclosed is an application container runtime (“ACR”) designed to integrate with existing operating system components. The ACR is designed for minimal system resource drain while providing a number of options for security/system access privileges of applications running including container and virtual machine security levels. The ACR integrates with existing operating system daemon processes and does not include a centralized daemon process internally.

### TECHNICAL FIELD

Teachings relate to computer operating system software components. More specifically, teachings herein relate to runtimes for application container images.

### BACKGROUND

An application container is a way of packaging and executing processes on a computer system that isolates the application from the underlying host operating system. For example, a Python web app packaged as a container would bring its own copy of a Python runtime, shared libraries, and application code, and would not share those packages with the host.

Application containers are useful because they put developers in full control of the exact versions of software dependencies for their applications. This reduces surprises that can arise because of discrepancies between different environments (like development, test, and production), while freeing the underlying OS from worrying about shipping software specific to the applications it will run. This decoupling of concerns increases the ability for the OS and application to be serviced for updates and security patches.

Despite this, application containers use more system resources than uncontained processes. Thus balancing system security and adaptability concerns with processing resource concerns is a struggle of operating system developers.

### INCORPORATION BY REFERENCE

Numerous program code files are submitted simultaneously with this application on compact disc. The program files provide a specific implementation of embodiments of the invention written in the programming language, “Go.” The incorporated program code files are written in a number of file formats including Go and makefiles (.mk). Each of these files has been altered to a simple text file (.txt) for the purposes of submission to the USPTO. In some cases where multiple file types with the same name were present and duplicate file names would have been created, the original file type has been included in the file name. Altering the name of files causes compiling errors, thus a careful review of the incorporated code files is necessary. The program files are arranged in an organized file hierarchy which certain portions of the program code references. These attached files are hereby incorporated by reference in their entirety as if reprinted here.

Copies of the program code files are additionally available online in a GitHub library under coreos/rkt (https://github.com/coreos/rkt). To the extent that the cited online code repository is able to demonstrate its own contents on the date of filing of the present application, the time-dated program code and file hierarchy is also incorporated by reference in their entirety.

### BRIEF DESCRIPTION OF FIGURES

FIG. 1 is a graph of privilege levels associated with system resource costs;

FIG. 2 is a block diagram of a system in which the ACR operates, according to various embodiments;

FIG. 3 is a flowchart illustrating steps of the ACR, stage zero (0), according to various embodiments;

FIG. 4 is a flowchart illustrating steps of the ACR, stage one (1) and stage two (2), according to various embodiments;

FIG. 5 is a diagram illustrating architecture of the ACR, stage one (1), with respect to integration with systemd daemon according to various embodiments; and

FIG. 6 is a diagram illustrating architecture of the ACR compared to other runtime solutions that utilize centralized daemon processes.

### DETAILED DESCRIPTION

The Application Container Runtime (ACR) defines what environment and facilities a container runtime should provide. This includes devices, environment variables, and privileges that a container should expect. The ACR also includes a definition of a meta-data service interface for exposing data to the environment from outside the container.

Security primitives are very important, therefore the ACR includes an identity feature to the meta-data service. This means every instance of a running container is given a unique identity, coupled with a lightweight hardware security module(HSM)-like service for signing.

The ACR is designed to have clean integration points, use simple, composable container units, and comprise only of a command-line tool, without a daemon. This architecture allows the ACR update in-place without affecting application containers that are currently running The architecture also enables the selection of levels of privilege which are separable between different operations.

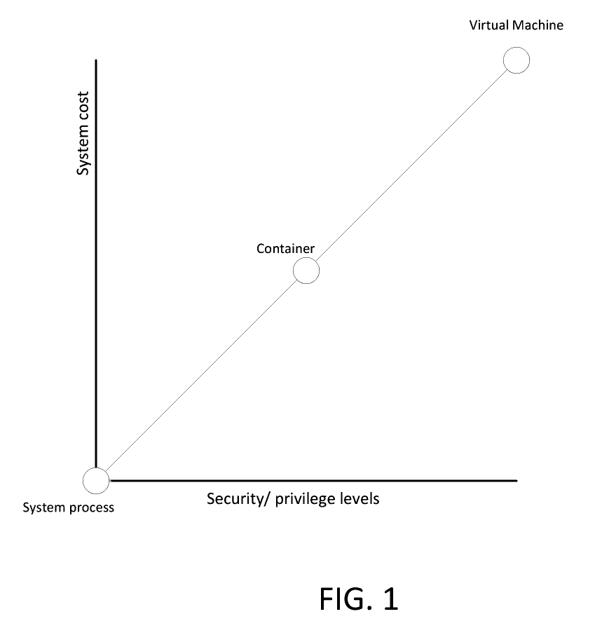

FIG. 1 is a graph of privilege levels associated with system resource costs. The plotted factors are directly related. While the relationship is not necessarily 1:1 linear as depicted, as one increases, so does the other. At the origin, the least secure architecture, with the most privilege are system processes. Processes without containment are often administrative or internally designed and trusted.

The strongest security and greatest systems cost shown on the graph are virtualized machines. Virtual machines are sometimes referred to as sandboxes. Virtualized machines communicate to the host machine through a hardware abstraction which has an increased system cost, but is more secure because API surface area is smaller and there is an inability to communicate with exterior processes.

In the middle are containers. Containers are effectively very lightweight virtual machines which allow code to run in isolation from other containers but safely share the machine's resources, all without the overhead of a hypervisor. Examples of containers include software constructs like Linux containers (LXC). Containers isolate applications running inside the container from accessing all system resources as system processes do. As a result, the container has to generate some environment elements in order for the application to run, and this has an associated system cost. However, not all elements are recreated, and thus there is some security risk as applications running in the container sometimes need to access some limited elements outside of the container.

While there is a default selection, such as the use of containers, the ACR is programmed to allow the user to select via a command line, based on context, a level of security for the environment a given application container image is run in.

The image format defined by appc and used in the ACR is the application container image, or ACI. An ACI is a simple tarball bundle of a rootfs (containing all the files needed to execute an application) and an image manifest, which defines things like default execution parameters and default resource constraints. ACIs are built with tools like “actool” or “goaci.” Images from the “Docker” platform can be converted to ACI using the “docker2aci” library. The ACR enables parameters defined in an image to be overridden at runtime through use of a run command which allows users to supply custom exec arguments to an image.

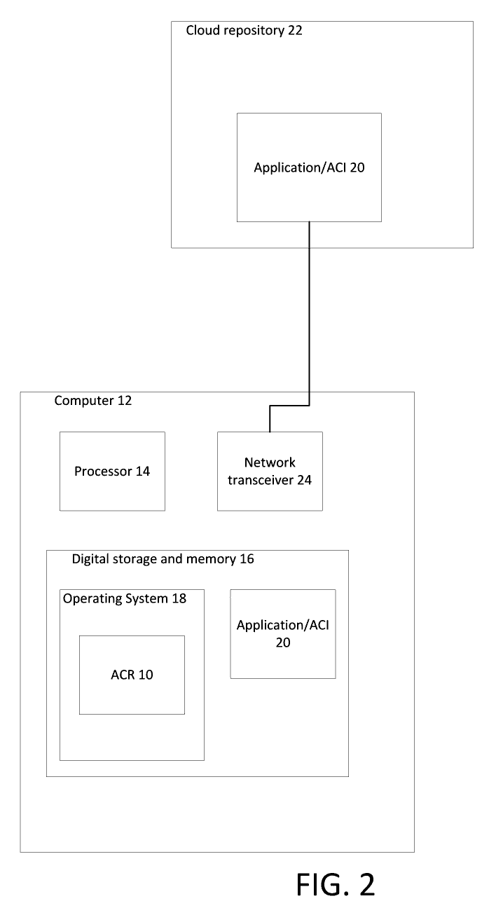

FIG. 2 is a block diagram of a system in which the ACR 10 operates. The ACR 10 runs on a computer 12. The computer 12 is processor 14 driven. Computer 12 in this case refers to servers, personal computers, mobile devices, tablets, and other suitable processor-operated devices known in the art. Located on the computer 12 is local hard disk digital storage and memory 16. In operation, memory 16 is allocated for use to run an operating system 18. The ACR 10 operates in conjunction with the operating system 18.

During operation the ACR 10 obtains an application using an ACI 20. The ACI 20 is located on a digital data repository. The digital data repository may be the local hard disk storage or memory 16 or a cloud repository 22 which the computer 12 communicates with through a network transceiver 24. A cloud repository 22 includes app stores such as Google Play or the Apple Store, or other web locations from which applications or other hosted content is provided to users.

The ACR 10 is programmed to communicate state through the filesystem. Facilities like file-locking are used to ensure co-operation and mutual exclusion between concurrent invocations of the ACR 10 command line.

The ACR 10 executes in distinct stages. For purposes of aligning with incorporated program code, these stages are numbered 0, 1 and 2.

Stage 0

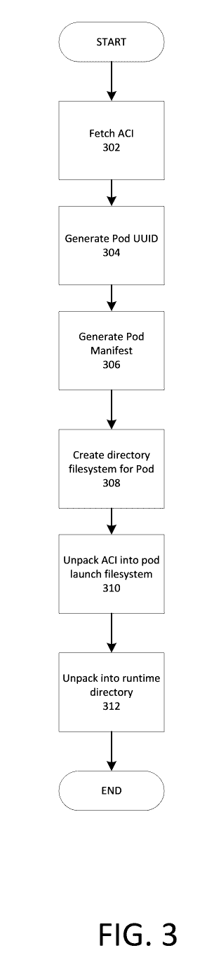

FIG. 3 is a flowchart illustrating steps of the ACR 10, stage 0, according to various embodiments. Stage 0 comprises the binary of the ACR 10. The ACR 10 uses a program construct referred to as a pod. A pod is a group of containers that are scheduled onto the same host. Pods serve as units of scheduling, deployment, and horizontal scaling/replication. Pods share fate, and share some resources, such as storage volumes and IP addresses.

When running a pod, the ACR binary is responsible for performing a number of initial preparatory tasks. First, in step 302, fetching the specified ACIs, including the stage 1 ACI 20 of—stage1-image if specified. Next, in step 304, generating a Pod universally unique ID. Then, in step 306, generating a Pod Manifest. In some embodiments, the Pod Manifest is compliant with the Application Container Executor (ACE) spec of the Application Contain spec (“APPC”) code library on GitHub. Next, in step 308, creating a filesystem for the pod. The filesystem includes, setting up stage 1 and stage 2 directories in the filesystem. An illustrative file system is as follows:

/pod
/stage1
/stage1/manifest
/stage1/rootfs/init
/stage1/rootfs/opt
/stage1/rootfs/opt/stage2/${app1-name}
/stage1/rootfs/opt/stage2/${app2-name}
/stage1/rootfs/opt/stage2/${appN-name}

Once the file system is constructed, in step 310, unpacking the stage 1 ACI 20 into the pod filesystem. Finally, in step 312, unpacking the ACIs 20 and copying each app into the stage2 directories.

At this point the stage0 executes /stage1/rootfs/init with the current working directory set to the root of the new filesystem.

Stage 1

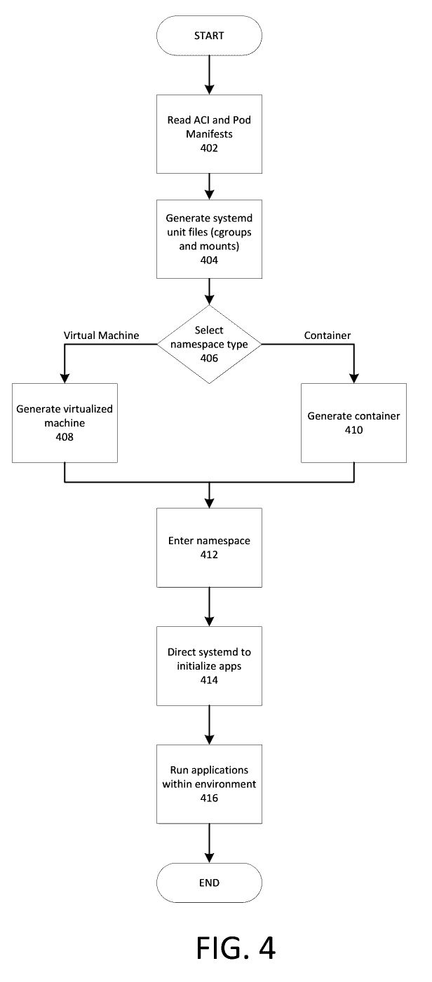

FIG. 4 is a flowchart illustrating steps of the ACR 10, stage one (1) and stage two (2), according to various embodiments. Stage 1, is a binary that the user trusts to set up cgroups, execute processes, and perform other operations as root on the host. This stage has the responsibility of taking the pod filesystem that was created by stage 0 and creating the necessary cgroups, namespaces and mounts to launch the pod. Specifically, stage 1 activities include:

In step 402, reading the ACI 20 and pod manifests. The ACI Manifest defines the default execution specifications of each application. The pod manifest defines the ordering of the units, as well as any overrides.

In step 404, generate systemd unit files from the pod manifests. Systemd is a software suite for central management and configuration of the Linux Operating System and comprises a number of server daemons. While examples in this disclosure refer directly to “systemd” relating to Linux in a particular implementation of the present invention, daemon processes of other operating systems may substitute.

In step 406, the type of environment in which the application will run is determined. There are a number of selectable program constructs available. Two such options are virtual machines or containers. Each program construct has predetermined resource system requirements and system access privileges as discussed in FIG. 1. The determination is made either through user input via a command line, or from other configuration files (such as a pod manifest) associated with the ACI 20.

In steps 408 and 410 the ACR executes the choice of step 406, and creates and network namespaces/cgroups. Once again the terms namespace and cgroup refer to Linux Operating System features. Corresponding and equivalent features exist in other known operating systems which also suffice. In step 412, processing of the ACI enters the created program construct of step 408 or 410.

In step 414, the ACR 10 starts systemd-nspawn. Within step 414 the ACR sets up any external volumes, launches systemd as PID 1 in the pod within the appropriate cgroups and namespaces, and has systemd launch the app(s) inside the pod. Systemd-nspawn refers to a particular implementation. A similar result is achieved through starting qemu-kvm. This process is slightly different for the qemu-kvm stage1 but a similar workflow starting at executing kvm instead of an nspawn.

Stage 2

In step 416, the final stage, stage2, is the actual environment in which the applications run, as launched by stage1.

Stage 1 Systemd Architecture

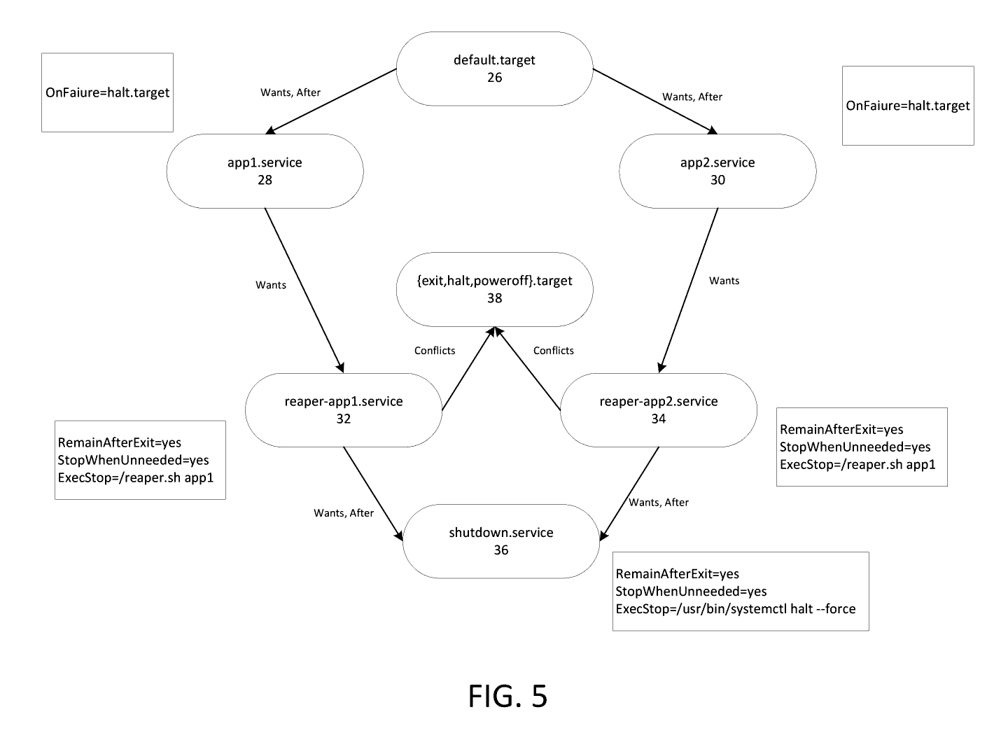

FIG. 5 is a diagram illustrating architecture of the ACR 10, stage one (1), with respect to integration with systemd daemon according to various embodiments. In one implementation of the ACR's Stage 1, there is a very minimal systemd that takes care of launching the applications in each pod, apply per-application resource isolators, and make sure the apps finish in an orderly manner. FIG. 5 pertains to a specific Linux implementation and others are possible on other operating systems with corresponding daemon processes.

Given a systemd ACR application target (default.target) 26 which has a Wants and After dependency on each app's service file (app1 28 and app 2 30), making sure each starts. Each app's service 28, 30 has a Wants dependency on an associated reaper service 32, 34 that deals with writing the app's status exit. Each reaper service 32, 34 has a Wants and After dependency with a shutdown service 36 that simply shuts down the pod.

The reaper services 32, 34 and the shutdown service 36 all start when each respective application 28, 30 launches but do nothing and remain after exit (with the RemainAfterExit flag). By using the StopWhenUnneeded flag, whenever the reaper services 32, 34 and shutdown service 36 stop being referenced, each does the actual work via the ExecStop command.

This means that when an app service 28, 30 is stopped, the associated reaper service 32, 34 writes an exit status in an appropriate folder (in the incorporated code implementation of code files, that folder is /rkt/status/${appN}) and other apps will continue running When all apps' 28, 30 services stop, the associated reaper services 32, 34 also stop and cease referencing the shutdown service 36 causing the pod 26 to exit. Each app service 28, 30 has an OnFailure flag that starts the halt.target. This means that if any app in the pod exits with a failed status, the systemd shutdown process will start, the other apps' services will automatically stop and the pod will exit.

A Conflicts dependency exists between each reaper service 32, 34 and the halt and poweroff targets 38 (poweroff is triggered when the pod is stopped from the outside when the ACR 10 receives SIGINT). This will activate all the reaper services 32, 34 when one of the targets is activated, causing the exit statuses to be saved and the pod 26 to finish as described in the previous paragraph.

In short, each application running out of a pod, is programmed to have individual exit/garbage collection processes which begin operation as soon as an app launches. Because there are individual, dedicated exit/garbage collection processes, ending the execution of a given application has negligible or no effect on the processes of other applications from the same pod.

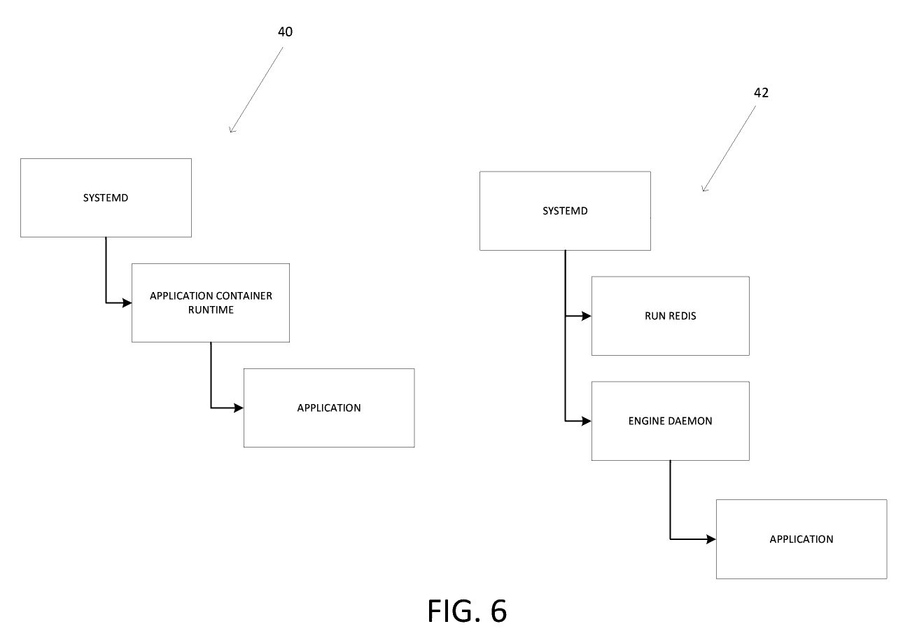

FIG. 6 is a diagram illustrating architecture of the ACR compared to other runtime solutions that utilize centralized daemon processes. On the left the present ACR system 40 is drawn with respect to daemon processes. On the right, an alternate runtime environment system 42 is shown that includes a central daemon process. An example of an alternate runtime environment is the “Docker Engine,” though several other examples of runtime environments which include central daemon processes exist.

The ACR 10 comprises only a command-line tool, and does not have a daemon. This architecture allows the ACR 10 to be updated in-place without affecting application containers which are currently running It also means that levels of privilege can be separated out between different operations. All state in the ACR 10 is communicated via a filesystem. Facilities like file-locking are used to ensure co-operation and mutual exclusion between concurrent invocations of the command-line command.

In operation Docker Engine 42, uses a central daemon to download container images, launches container processes, exposes a remote API, and acts as a log collection daemon, all in a centralized process running as root. While such a centralized architecture is convenient for deployment, it does not follow best practices for Unix process and privilege separation; further, central daemon processes make it difficult to properly integrate with Linux init systems such as upstart and systemd. Since running a container from the command line communicates only with the central daemon API, which is in turn responsible for creating the container, init systems are unable to directly track the life of the actual container process.

On the other hand, an ACR 10 where there is no centralized “init” daemon, operation proceeds instead by launching containers directly from client commands. This is compatible with init systems such as systemd, upstart, and others.

1. A processor-implemented method for establishing runtime environments for application images comprising:
fetching, by a processor from a digital data repository, an application container image;
generating, by the processor, a pod with a universally unique identifier, a pod manifest, a directory filesystem, and including at least the application container image;
determining, by the processor via analysis of the pod manifest, application system privilege levels for the application container image;
generating, by the processor via analysis of the pod manifest, system unit files for the application container image comprising cgroups, namespaces, and pod launch mounts wherein the system unit files are configured to execute the determined system privilege levels;
inserting, by the processor, the application container image into the generated system unit files;
launching, by the system unit files, the application container image.

2. The method of claim 1, wherein the application system privilege levels are fixed static options comprising:
container; or
virtual machine.

3. The method of claim 2, wherein the fixed static options further comprise:
unrestricted.

4. The method of claim 1, wherein the unit files are launched directly from client commands thereby interfacing directly with the Linux “systemd,” system daemon.

5. The method of claim 1, wherein said determining and generating steps occur within a container software construct.

6. The method of claim 4, further comprising:
ending, by the unit files, processing of the application container image; and
freeing system resources through a dedicated garbage collection process associated with no other application container images.

7. The method of claim 4, wherein the systemd executes said launching step.

8. The method of claim 4, wherein said determining and generating steps occur within a Linux container software construct and are facilitated by base operating system “systemd” daemon init processes without the aid of a centralized daemon process.

9. A processor-implemented method for establishing runtime environments for application images comprising:
obtaining, by a processor, an application container image;
determining, either by configuration files or by input through a user command line, application system privilege levels for the application container image;
generating, by the processor, an application runtime environment conforming to the determined application system privilege levels; and
wherein the application system privilege levels each correspond to predetermined program constructs with preset system privileges.

10. The method of claim 9, wherein the application runtime environment is one of:
a container; or
a virtual machine.

11. The method of claim 10, wherein the possibilities of application runtime environments further comprise:
unrestricted system operations.

12. The method of claim 9, wherein the application runtime environment is launched directly from client commands thereby interfacing directly with the Linux “systemd” system daemon.

13. The method of claim 9, wherein said determining and generating steps occur within a container software construct.

14. The method of claim 9, further comprising:
ending, by the application runtime environment, processing of the application container image; and
freeing system resources through a dedicated garbage collection process associated with no other application container images.

15. A processor-implemented system for establishing runtime environments for application images comprising:
a processor programmed to:
obtain an application container image;
determine from either a configuration file or from input through a user command line, application system privilege levels for the application container image;
generate a variable application runtime environment conforming to the determined application system access privilege levels; and
a variable application runtime environment configured by the processor and including an application container image, wherein the variable application runtime environment is either a container or a virtual machine as determined by the system access privilege levels, and is programed to launch the application container image.

16. The system of claim 15, wherein the application runtime environment is one of:
a container; or
a virtual machine.

17. The system of claim 16, wherein the possibilities of application runtime environments further comprise:
unrestricted system operations.

18. The system of claim 15, wherein the application runtime environment is launched directly from client commands thereby interfacing directly with the “systemd” system daemon.

19. The system of claim 15, wherein said determine and generate processor programming steps occur within a container software construct.

20. The system of claim 15, wherein the variable application runtime environment is further programmed to:
end processing of the application container image; and
integrate with a Linux systemd daemon process to free system resources through a dedicated garbage collection process associated with no other application container images.
